(19) United States
(12) Patent Application Publication
(10) Pub. No.: US 2009/0066145 A1
(43) Pub. Date: Mar. 12, 2009

(54) Seatbelt shoulder strap management device

(76) Inventor: James E. McWhirt, JR., Sims, IN (US)

Correspondence Address: James E. McWhirt Jr., 105 N Davis Street, Sims, IN, 46986, US

(21) Appl. No.: 11/900,351

(22) Filed: Sep. 11, 2007

(51) Int. Cl. B60R 22/00; B60R 22/12

(52) U.S. Cl. 297/468; 280/808

(57) ABSTRACT

A managing device for use by an adult to compel the shoulder strap of a seatbelt restraint system from chaffing or irritating the user's neck in anyway without compromising the integrity or purpose of the restraint system.

### FIELD OF INVENTION

This invention relates to the use of a shoulder strap in the seatbelt assembly, more particularly, to the comfort of the shoulder strap and safety of the passengers.

### BACKGROUND OF INVENTION

Seatbelts have been modified through the years but with the same purpose in mind which is to protect the vehicle passengers from injury in minor accidents and to save lives in more serious accidents. The problem of shoulder belts is the discomfort that has been an issue since the seatbelt first came into use. This invention will be used to eliminate the body coming into contact with the upper portion of the shoulder strap and therefore removing the crushing feeling accompanied with the seatbelt use.

### BRIEF SUMMARY OF INVENTION

The seatbelt, even when adjusted according to body size, over the lap is still not adjusted in correct proportion to the upper body size. This device, when attached to the shoulder restraint, permits the occupant to adjust the upper seatbelt to his/her own body size. This therefore prevents the rubbing or chaffing of the neck while providing comfort and maintaining the safety with which a seatbelt was intended.

### DETAILED DESCRIPTION OF INVENTION

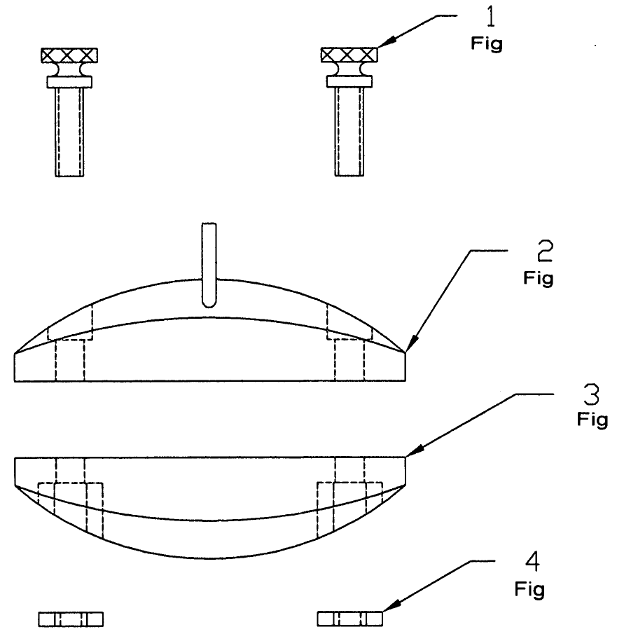

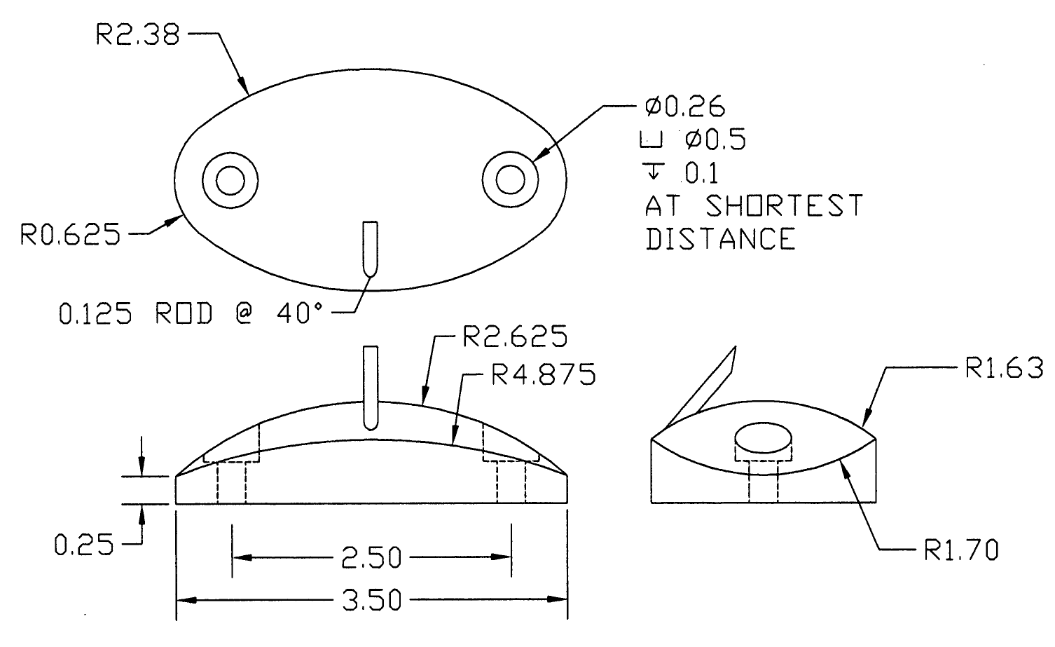

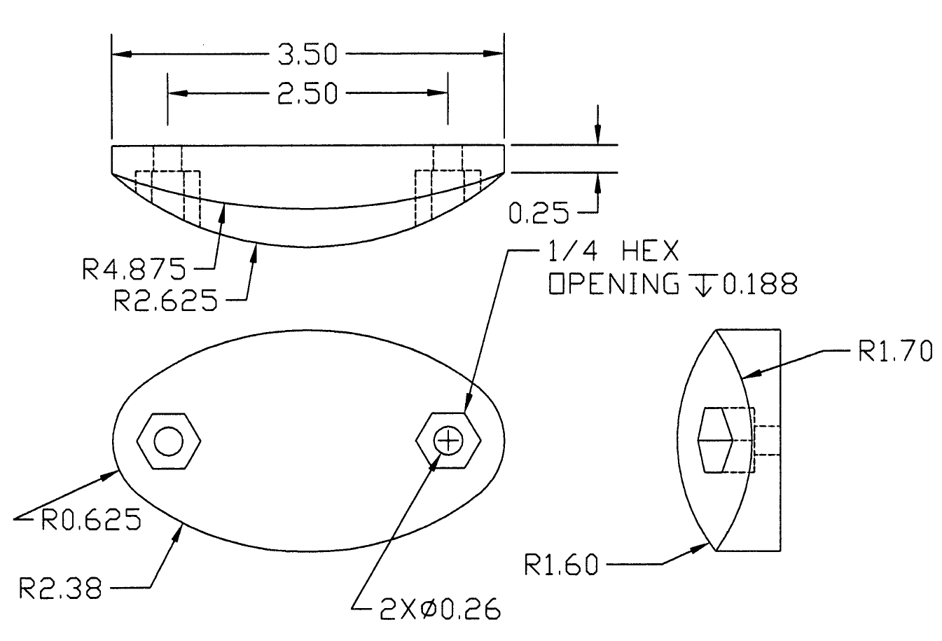

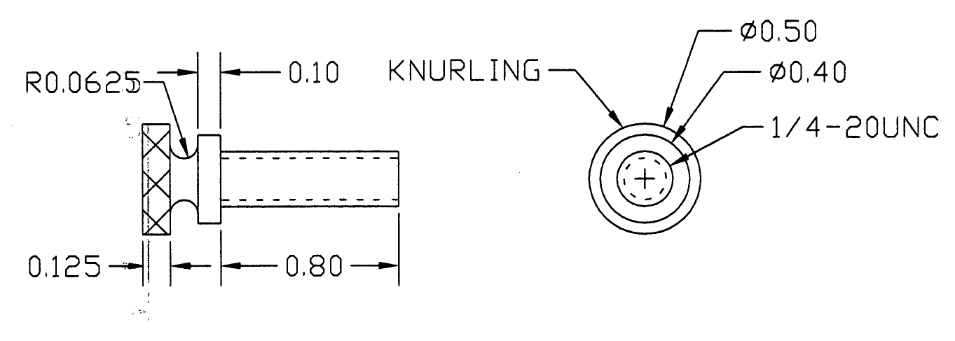

This device can be used on any seatbelt, in particular, the shoulder strap to increase the comfort of wearing the shoulder strap and therefore increasing the percentage of people who wear seatbelts. The use of this invention is to make wearing a seatbelt more comfortable by reducing the choking and chaffing feeling passengers get from wearing the seatbelt. The invention is made by injecting polyurethane plastic into a mold. The invention itself consists of a top (FIG. 2) and bottom (FIG. 3) that is held together by two screws (FIG. 1) that are secured on by hex nuts (FIG. 4). Before assembly the shoulder strap is placed between the top and bottom plates where the screws are places downward through the bottom part and a hex nut is then placed on the thumb screw. The invention will then slide upward to be adjusted as to each passenger's size and comfort. To achieve this each passenger must first buckle the seatbelt, and then adjust the device by sliding upward toward the top of the shoulder strap. By placing a flat hand between the shoulder strap and the chest a passenger will then be able to adjust the device until it is comfortable. This allows the passenger to be comfortable without risking their safety. There have been many attempts to achieve the comfort and still keep the integrity of the seatbelt use. Devices that connect the lap belt and the shoulder strap are bulky and seem to need to be separated and reconnected with each use. This invention stays in position after being used and can be changed easily for each passengers use. A passenger only needs to loosen the thumb screws on one side and then slide the device up or down to adjust to their size and comfort level. This device can easily be stored away when not in use by using the eye of the metal buckle connection and placing the eye of the buckle on the hook found on top of this device, by hanging this end of the seatbelt connection, it keeps the seatbelt from being closed in the vehicle doors. The passengers can then simply reach up and unhook the seatbelt and buckle up.

### DESCRIPTION OF DRAWINGS

Parts List

| Figure # | Part Name | Qty. |
|---|---|---|
| 1 | THUMB SCREW (page 4) | 2 |
| 2 | TOP (page2) | 1 |
| 3 | BOTOM (page 3) | 1 |
| 4 | ½ 20UNC HEX NUT | 2 |

Page 1
Exploded Assembly

Scale 1 to 1
Date: Apr. 4, 2007

Page 2
Part Name: Top

Scale: 1 to 1
Date: Apr. 4, 2007

Page 3
Part Name: Bottom

Scale 1 to 1
Date: Apr. 4, 2007

Page 4
Part Name: Thumb Screw

Scale: 2 to 1
Date: Apr. 4, 2007

1. What I claim for my invention is: that it prevents the shoulder strap of a restraint system from chaffing or choking of the neck.

2. I claim that it prevents crushing items that are in a left pocket of clothing.

3. I claim that most people would more readily use a seatbelt restraint as this invention renders the restraint system more comfortable.
